(19) United States
(12) Patent Application Publication
(10) Pub. No.: US 2026/0289805 A1
(43) Pub. Date: Sep. 24, 2026

(54) INFORMATION PROCESSING METHOD, INFORMATION PROCESSING APPARATUS, INFORMATION PROCESSING PROGRAM, AND INFORMATION PROCESSING SYSTEM

(71) Applicant: Sony Group Corporation, Tokyo (JP)

(72) Inventor: Mai KADO, Kanagawa (JP)

(73) Assignee: Sony Group Corporation, Tokyo (JP)

(21) Appl. No.: 19/480,257

(22) PCT Filed: Mar. 27, 2024
(86) PCT No.: PCT/JP2024/012161

§ 371 Date: Oct. 30, 2025

(30) Foreign Application Priority Data
May 15, 2023 (JP) 2023-080156

(51) Int. Cl. G06T 7/571; G05D 1/622; G05D 109/25

(52) U.S. Cl. CPC G06T 7/571; G05D 1/637; G05D 2109/254; G06T 2207/10032; G06T 2207/30184; G06T 2207/30252

(57) ABSTRACT

An information processing method includes generating a first geofence spaced from a target object; generating a second geofence spaced from the target object and different from the first geofence; and generating, using the first geofence and the second geofence, a movement region in which a mobile object is movable.

### TECHNICAL FIELD

The present disclosure relates to an information processing method, an information processing apparatus, an information processing program, and an information processing system that are used when a mobile object moves around a target object, specifically, when an air vehicle flies around a three-dimensional target object.

### BACKGROUND ART

A technology is known that is used to inspect a three-dimensional target object such as a tunnel or a building using an air vehicle including a camera (Patent Literature 1).

### CITATION LIST

### Patent Literature

Patent Literature 1: Japanese Patent Application Laid-open No. 2022-106904

### DISCLOSURE OF INVENTION

### Technical Problem

The use of such an air vehicle including a camera enables image-capturing to be effectively performed on a state of a location that it is difficult for humans to enter. The effective image-capturing is expected to be useful in inspecting a target object that it is difficult for humans to approach, where examples of the target object include social infrastructures such as a bridge built over a river or the sea, a tunnel, a dam, and a road; and industrial infrastructures such as an airport, a building, a warehouse, a factory, and a plant.

In view of the circumstances described above, it is an object of the present disclosure to provide an information processing method, an information processing apparatus, an information processing program, and an information processing system that are used when a mobile object moves around a target object more properly, specifically, when an air vehicle flies around a three-dimensional target object more properly.

### Solution to Problem

An information processing method according to an embodiment of the present disclosure includes
generating a first geofence spaced from a target object;
generating a second geofence spaced from the target object and different from the first geofence; and
generating, using the first geofence and the second geofence, a movement region in which a mobile object is movable.

According to the present embodiment, it is sufficient if a model of an image-capturing-target object is scaled up or down, a range partitioned off by a plurality of models is defined as a closed three-dimensional space, and a mobile object moves in the movement region. This results in a relatively small amount of information to be processed during movement and in improving the reliability in obtaining an appropriate image safely.

The first geofence may be generated far from the target object using a first specified distance,
the second geofence may be generated far from the target object using a second specified distance, and
the first specified distance may be larger than the second specified distance.

The second geofence may be generated between the target object and the first geofence.

A recommended movement region in which the mobile object is recommended to move may be generated in the movement region.

According to the present embodiment, it is sufficient if the mobile object moves in the recommended movement region in the movement region. This results in a further relatively small amount of information to be processed for controlling the mobile object and in further improving the reliability in obtaining an appropriate image safely.

A movement route of the mobile object may be generated in the recommended movement region.

According to the present embodiment, it is sufficient if the mobile object moves on the movement route in the recommended movement region. This results in a further relatively small amount of information to be processed for controlling the mobile object and in further improving the reliability in obtaining an appropriate image safely.

The recommended movement region may be sliced to generate slices, the slices may be connected using a single line, and the slices and the single line may be converted into a figure drawn without going over the same line twice to generate a movement route of the mobile object in the recommended movement region.

The slicing interval and/or the slicing direction may be automatically determined on the basis of, for example, how long a battery life is, how short a total flight time is, and a level of being less likely to be affected by the wind. This makes it possible to generate an optimal movement route.

The movement route may be output to the mobile object.

According to the present embodiment, the mobile object can automatically move on the movement route.

A target-object model that is a model of the target object may be acquired, and the target-object model may be scaled up or down to generate each of the first geofence, the second geofence, and the recommended movement region.

This makes it possible to generate the respective models appropriate for each target object.

The target-object model, the first geofence, or the second geofence may be a 3D model.

This makes it possible to use original data of, for example, CAD.

The mobile object may include an image-capturing apparatus,
when an image of the target object is captured by 3D scanning,
   each of the first geofence, the second geofence, and the recommended movement region may be formed of a group of points situated at equal distances from a reference surface, with a surface of the target-object model being set to be the reference surface, and
   each of the first geofence, the second geofence, and the recommended movement region may be similar to the target-object model, and
when an ortho-image of the target object is captured,
   each of the first geofence, the second geofence, and the recommended movement region may be formed of a group of points situated at equal distances from a reference surface, with a surface of a refence model being set to be the reference surface, the reference model including at least a portion of a group of points forming the surface of the target-object model, and
   each of the first geofence, the second geofence, and the recommended movement region may be dissimilar to the target-object model.

According to the present embodiment, for example, different movement regions and different movement routes are generated by capturing ortho-images and by performing image-capturing by 3D scanning to generate a proper movement region and a proper movement route that are fit for the purpose. This makes it possible to perform image-capturing appropriately depending on the purpose.

The recommended movement region of which at least a portion includes a group of points each spaced at a recommended movement distance from a reference surface based on the target object may be generated,
the second geofence of which at least a portion includes a group of points each spaced at a minimum separation distance from the reference surface may be generated, and
the first geofence of which at least a portion includes a group of points each spaced at a maximum separation distance from the reference surface may be generated.

When the application is image-capturing by 3D scanning, three types of models that are each formed only of a group of points situated at equal distances from points of a group of points forming a surface (a reference surface) of a model of the target object, are generated. When the application is capturing of an ortho-image, a reference model that includes at least a portion of the group of points forming the surface of the model of the target object, is generated, and three types of models that are each formed only of a group of points situated at equal distances from points of a group of points forming a surface (a reference surface) of the reference model, are generated. This results in generating a proper movement region and a proper movement route that are fit for the purpose, and thus in being able to perform image-capturing appropriately depending on the purpose.

The mobile object may include an image-capturing apparatus,
a subject distance at which focus of the image-capturing apparatus is achieved when the image-capturing apparatus captures an image of the target object may be determined to be the recommended movement distance,
a near depth of field of the image-capturing apparatus may be subtracted from the subject distance to calculate the minimum separation distance, and
a far depth of field of the image-capturing apparatus may be added to the subject distance to calculate the maximum separation distance.

This makes it possible to move the mobile object in a range in which (with a depth of field with which) the focus of the image-capturing apparatus is achieved.

The mobile object may include an image-capturing apparatus,
a subject distance at which focus of the image-capturing apparatus is achieved when the image-capturing apparatus captures an image of the target object may be determined to be the recommended movement distance,
the subject distance may be determined to be the minimum separation distance, and
a far depth of field of the image-capturing apparatus may be added to the subject distance to calculate the maximum separation distance.

This makes it possible to capture an image of the target object in a state in which the mobile object is situated as close to the target object as possible, and to cause the focus of the image-capturing apparatus to be also achieved when the mobile object is distant from the target object.

A minimum distance, from the target object to the mobile object, that the mobile object is movable may be determined to be the minimum separation distance,
a maximum distance, from the target object to the mobile object, that the mobile object is movable may be determined to be the maximum separation distance, and
an average of the minimum separation distance and the maximum separation distance may be determined to be the recommended movement distance.

This makes it possible to move the mobile object in a maximum range in which an obstacle is physically not situated or in a maximum range in which an acceptable resolution can be obtained.

The mobile object may include an image-capturing apparatus,
the minimum separation distance may be calculated on the basis of a hyperfocal length of the image-capturing apparatus,
a distance at which the image-capturing apparatus exhibits a minimum resolution may be determined to be the maximum separation distance, and
an average of the minimum separation distance and the maximum separation distance may be determined to be the recommended movement distance.

This makes it possible to move the mobile object in a range in which the resolution does not fall below a minimum resolution, with the focus being adjusted to infinity.

An information processing apparatus according to an embodiment of the present disclosure includes
a computational apparatus
   that generates a first geofence spaced from a target object,
   that generates a second geofence spaced from the target object and different from the first geofence, and
   that generates, using the first geofence and the second geofence, a movement region in which a mobile object is movable.

An information processing program according to an embodiment of the present disclosure operates a computational apparatus of an information processing apparatus to
generate a first geofence spaced from a target object,
generate a second geofence spaced from the target object and different from the first geofence, and
generate, using the first geofence and the second geofence, a movement region in which a mobile object is movable.

An information processing system according to an embodiment of the present disclosure includes
a mobile object; and
an information processing apparatus including a computational apparatus
   that generates a first geofence spaced from a target object,
   that generates a second geofence spaced from the target object and different from the first geofence,
   that generates, using the first geofence and the second geofence, a movement region in which a mobile object is movable,
   that generates, in the movement region, a recommended movement region in which the mobile object is recommended to move,
   that generates a movement route of the mobile object in the recommended movement region, and
   that outputs the movement route to the mobile object.

### BRIEF DESCRIPTION OF DRAWINGS

FIG. 1 illustrates a functional configuration of an information processing system according to an embodiment of the present disclosure.

FIG. 2 illustrates a flow of an operation performed by the information processing system.

FIG. 3 illustrates a relative position (an inner side or an outer side) of a movement region relative to a target object.

FIG. 4 schematically illustrates a target object, a movement region situated around the target object, and a recommended movement region in the movement region.

FIG. 5 schematically illustrates the case in which a depth of field is specified.

FIG. 6 schematically illustrates the case in which a separation distance is specified.

FIG. 7 schematically illustrates the case in which a minimum distance and a maximum distance (or a maximum resolution and a minimum resolution) are specified.

FIG. 8 schematically illustrates the case in which a minimum resolution is specified.

FIG. 9 schematically illustrates image-capturing by 3D scanning and capturing of an ortho-image.

FIG. 10 schematically illustrates a method for generating a movement route.

### MODE(S) FOR CARRYING OUT THE INVENTION

### 1. Overview of Present Embodiment

The use of robotics such as drone upon performing inspection or survey has made progress. There is a need to inspect, for example, a wall surface of a target object by taking pictures of the target object using a drone.

When an air vehicle (a drone) is caused to fly around a three-dimensional target object (such as a building or a tunnel) to scan a surface of the three-dimensional target object, manual flight dependent on an experience of an operator is often adopted due to such a technology being less versatile. Most automatic flight-route creation systems specify linear flight routes or planar regions to control one-dimensional distances to structures.

In addition, there is a need to properly narrow a range in which focus is achieved, in order to use image-capturing data especially for the purpose of inspection. Most methods use autofocus functions and infinity focus lock of cameras.

For example, the reality is that, under the existing circumstances, people check a large number of pictures one by one to inspect a surface state of a target object. In order to perform such work, a picture including a blurred background is better since this results in reducing stress on eyes of a person upon recognition. In other words, it is desirable that a depth of field (a width, in a depth direction, that enables focus to be achieved) be made shallower such that only a damage or a surface of a target object comes into focus.

Further, when a picture of a portion of a target object is viewed, it is difficult to grasp which portion of the target object appears in the picture. For this reason, it is desirable that 3D data be generated in order to grasp the entirety of the target object. When a 3D picture is taken, it is also desirable that the picture include a blurred background, in order for a person to see the picture with his/her own eyes to easily understand, or in order to automatically separate the background using a machine.

Furthermore, it is desirable that the same focal length be maintained when pictures are combined in order to obtain, for example, a 3D picture. An ortho-image is captured, with the focus being adjusted to infinity. Thus, there is a need to perform image-capturing at a certain distance from a target object. When a small target object or a fine target object is scanned, it is difficult to perform image-capturing, with the focus being adjusted to infinity. Thus, it is necessary for a user to manually control a distance between a target object and an air vehicle. Further, it is difficult to secure a distance to capture an image of an edge portion.

Primary parameters for the depth of field are a focal length of a lens, an f-number of the lens (an aperture value indicating a brightness of the lens), and a distance to a subject from the lens. There are restrictions on parameters for a camera included in an air vehicle. For example, only a lens having a relatively small focal length of, for example, 28 mm or 35 mm can be included. The f-number is determined by being affected by weather or a shadow. There is a need to make a shutter speed lower. The f-number is often set to about 2.8 or 5.6 to secure brightness, in order to support image-capturing performed with natural light even on cloudy days. Since there are restrictions on parameters for a camera, there is no choice but to secure the picture quality by adjusting a distance between a subject and an air vehicle. However, it is difficult to adjust the distance precisely, and the adjustment is dependent on a skill of an operator who performs the adjustment manually.

Further, it is difficult to cause an air vehicle to automatically fly around a complicated structure such as an industrial plant. A specialist in operating a drone causes an air vehicle to fly, while performing visual confirmation such that the air vehicle does not collide with a target object or another obstacle. For example, a three-dimensionally created route is rotated three-dimensionally to perform visual confirmation such that an air vehicle does not collide with, for example, a target object. Furthermore, an air vehicle may be caused to fly in an internal structure, such as causing the air vehicle to fly in a tunnel to inspect an inner wall surface of the tunnel. In this case, it is difficult to determine collision three-dimensionally in advance using original data of, for example, CAD. Thus, even if data of, for example, CAD is available, it will be difficult to use such data for automatic flight of an air vehicle.

On the other hand, an image-capturing position may be shifted from a planned image-capturing position upon operating a drone due to the wind or an error in global navigation satellite system (GNSS) data. In order to check whether there is a problem with such data, there is a need to visually check the image-capturing data itself or to check all of the image-capturing data on another system. This results in it taking time.

In view of the circumstances described above, according to the present embodiment, a movement region that is a closed three-dimensional space in which a mobile object (typically an air vehicle, and the same applies to the following description) can move around a target object (typically a three-dimensional target object, and the same applies to the following description) is generated. The movement region is an aerial three-dimensional region that is situated around a target object and in which an air vehicle can capture an image of the target object to obtain an appropriate image. It is sufficient if an operator causes an air vehicle to fly in the movement region upon performing the flight of the air vehicle by manual operation. This results in an easier operation and thus in improving the reliability in obtaining an appropriate image.

Further, according to the present embodiment, a movement route of a mobile object is generated in the movement region. The generation of the movement route in the movement region makes it possible to generate the movement route more easily and properly, and thus to cause the air vehicle to fly automatically.

Further, according to the present embodiment, the movement region and the movement route are generated more properly in order to perform image-capturing appropriately depending on the purpose. For example, different movement regions and different movement routes are generated by capturing ortho-images and by performing image-capturing by 3D scanning to generate a proper movement region and a proper movement route that are fit for the purpose.

Embodiments according to the present disclosure will now be described below with reference to the drawings.

### 2. Functional Configuration of Information Processing System

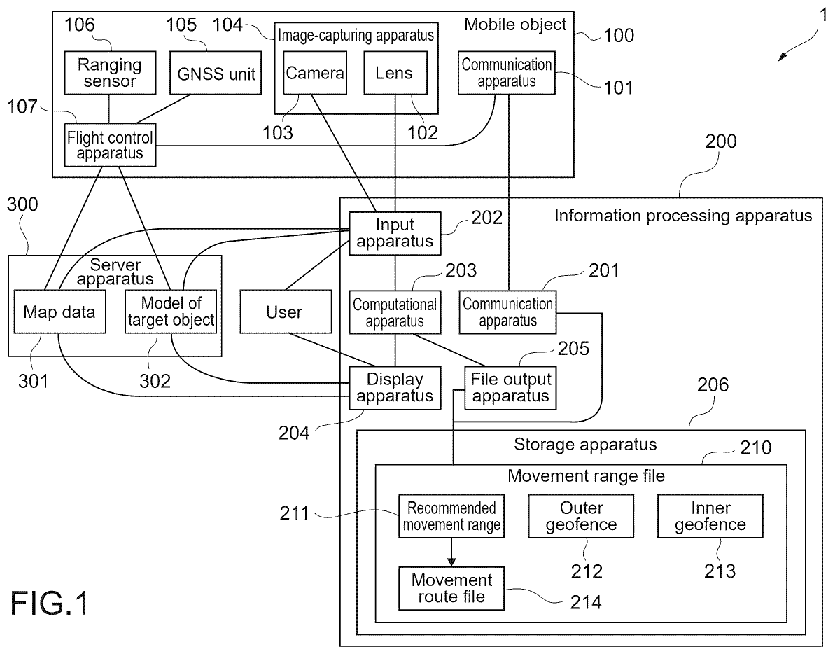

FIG. 1 illustrates a functional configuration of an information processing system according to an embodiment of the present disclosure.

An information processing system 1 includes a mobile object 100, an information processing apparatus 200, and a server apparatus 300. The mobile object 100, the information processing apparatus 200, and the server apparatus 300 are connected to each other to be capable of wirelessly communicating with each other through a network such as the Internet.

Typically, the mobile object 100 is an air vehicle (a drone) that can move (fly) three-dimensionally, and is described below as an air vehicle in the present embodiment. On the other hand, the mobile object 100 may be a mobile object, such as an automatic guided vehicle (AGV), an autonomous mobile robot (AMR), or an automated driving vehicle, that can travel two-dimensionally.

The mobile object 100 includes a communication apparatus 101, an image-capturing apparatus 104 that includes a lens 102 and a camera 103 (an image sensor), a GNSS unit 105, a ranging sensor 106, and a flight control apparatus 107 that includes a flight mechanism and a control circuit. The communication apparatus 101 is an interface used to communicate with the information processing apparatus 200. The image-capturing apparatus 104 captures an image of a target object during flight of the mobile object 100 to generate a captured image. The GNSS unit 105 acquires position information transmitted by a GNSS satellite, and current-location information based on, for example, time information. The ranging sensor 106 is a sensor (an active sensor) of a type that outputs a signal of, for example, electromagnetic waves, light, or sound to environment and that receives reflected waves. For example, the ranging sensor 106 is a time-of-flight (TOF) sensor, LiDAR, a millimeter-wave radar, and/or an ultrasonic sonar. The flight control apparatus 107 controls the flight mechanism using the control circuit to cause the mobile object 100 to fly.

The information processing apparatus 200 is, for example, a terminal apparatus such as a personal computer or a tablet computer. Typically, the information processing apparatus 200 is used by a user such as a worker who wants to inspect a target object using the mobile object 100 or an operation specialist in causing the mobile object 100 to fly. The information processing apparatus 200 generates a movement range used by the mobile object 100 to move (fly) around a target object to capture an image of the target object, and generates a movement route in the movement range. Typically, the “target object” used herein is a three-dimensional target object such as a building or a tunnel. However, the target object may be a lot of a planar land such as cultivated fields, or a target object, such as a pipeline provided along a land, that is laid on a land and that has substantially no height. The “image-capturing” used herein includes all of capturing still-image data to accumulate the captured data in a recording medium, capturing a video to display video data on a display apparatus in real time, and accumulating the video data in a recording medium.

The server apparatus 300 stores therein at least a portion of data necessary for the information processing apparatus 200 to generate a movement range and a movement route, and supplies the stored data to the information processing apparatus 200. Specifically, the server apparatus 300 stores therein 2D and/or 3D map data 301, and a 2D and/or 3D model 302 of a target object of which an image has been captured, and supplies the stored data and model to the information processing apparatus 200. A single server apparatus 300 or a plurality of server apparatuses 300 may be used.

When, for example, a target object is an artificial three-dimensional structure such as a bridge, a building, a tunnel, or a factory plant, the model 302 of the target object may be, for example, 3D CAD data used for, for example, designing of the three-dimensional structure. Alternatively, the model 302 of a target object may be a 3D model being obtained by performing scanning roughly using, for example, SLAM or a ToF sensor and having no texture, or a simple three-dimensional model having a shape of, for example, a cylinder or a rectangular parallelepiped. When the air vehicle 100 is caused to automatically or manually fly around a three-dimensional structure such that the three-dimensional structure is scanned, there is a need to use the 3D model 302 of a target object. When a target object is a lot of a planar land such as cultivated fields, or a target object, such as a pipeline provided along a land, that is laid on a land and that has substantially no height, the model 302 of the target object may be a 2D model. Further, when, for example, a lot of a planar land such as cultivated fields is inspected or surveyed, there is not necessarily a need for the model 302 of a target object, and only the map data 301 may be used. Note that the model 302 of a target object is described as a 3D model in the present embodiment.

The information processing apparatus 200 includes a communication apparatus 201, an input apparatus 202, a computational apparatus 203, a display apparatus 204, a file output apparatus 205, and a storage apparatus 206. The communication apparatus 201 is an interface used to communicate with the mobile object 100. The input apparatus 202 acquires data input by the server apparatus 300, and a parameter input by a user. The computational apparatus 203 calculates a recommended movement region 211, an outer geofence 212 (a first geofence), an inner geofence 213 (a second geofence), and a movement route 214 of the mobile object 100, and generates a movement range file 210 that includes those pieces of information (a method and the others for the calculation and generation will be described in detail later). The display apparatus 204 displays thereon, for example, the movement range 210 and movement route 214 generated by the computational apparatus 203 such that the movement range 210 and movement route 214 can be recognized by a user. The file output apparatus 205 records, in the storage apparatus 206, the movement range file 210 generated by the computational apparatus 203, and transmits the recorded movement range file 210 to the mobile object 100 through the communication apparatus 201.

Note that the system configuration described above is merely an example. For example, data stored in the server apparatus 300 may be stored in the mobile object 100 and/or the information processing apparatus 200. Instead of the information processing apparatus 200, the server apparatus 300 and/or the mobile object 100 may generate a movement range and/or a movement route. The lens 102 and the camera 103 may communicate with the mobile object 100 without being included in the mobile object 100.

### 3. Flow of Operation Performed by Information Processing System

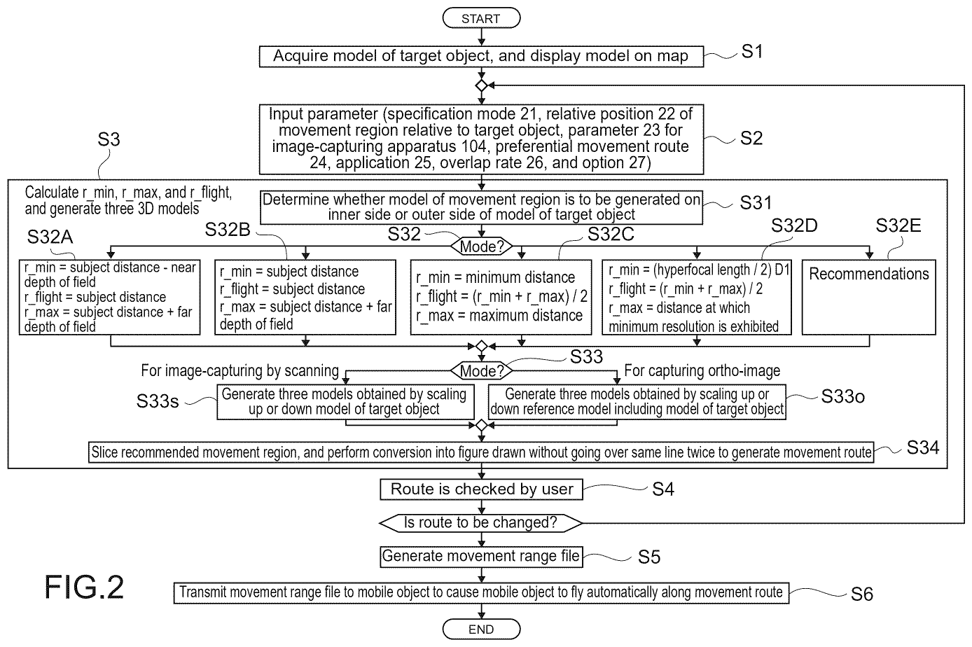

FIG. 2 illustrates a flow of an operation performed by the information processing system.

The input apparatus 202 of the information processing apparatus 200 acquires the map data 301 and the model 302 of a target object that are stored in the server apparatus 300. The computational apparatus 203 superimposes to draw the model 302 of the target object on a map drawn using the map data 301, and causes the model 302 of the target object on the map to be displayed on the display apparatus 204 viewed by a user (Step S1). The user may be an operator for a manual flight or a supervisor for an automatic flight.

Next, the user inputs, using the input apparatus 202, parameters used to generate a movement region in which the mobile object 100 can move. Alternatively, the parameters may be input automatically (Step S2). The parameters include a specification mode 21, a relative position 22 of the movement region relative to the target object, a parameter 23 for the image-capturing apparatus 104, a preferential movement route 24, an application 25, an overlap rate 26, and another option 27.

The specification mode 21 is a target that the user wants to specify with priority, and is specifically related to a distance or a resolution. For example, the specification mode 21 is one of a depth of field A, a separation distance to a target object B, a minimum distance and a maximum distance (or a maximum resolution and a minimum resolution) C, a minimum resolution D, and recommendations E. Specifically, when the user wants to move the mobile object 100 in a range in which the focus of the image-capturing apparatus 104 is achieved, the user specifies a value of the depth of field A as a parameter. When the user wants to capture an image of a target object in a state in which the mobile object 100 is situated as close to the target object as possible and wants the focus of the image-capturing apparatus 104 to be also achieved when the mobile object 100 is distant from the target object, the user specifies a value of the separation distance B as a parameter. When the user wants to move the mobile object 100 in a maximum range in which an obstacle is physically not situated or in a maximum range in which an acceptable resolution can be obtained, the user specifies values of the minimum distance and maximum distance (or the maximum resolution and minimum resolution) C as parameters. When the user wants to move the mobile object 100 in a range in which the resolution does not fall below a minimum resolution, with the focus being adjusted to infinity, the user specifies a value of the minimum resolution D as a parameter. When the recommendations E are specified by the user, the computational apparatus 203 specifies, as the specification mode 21, one of the parameters A) to (D according to various parameters. Processes related to the parameters A) to (D will be described in detail later.

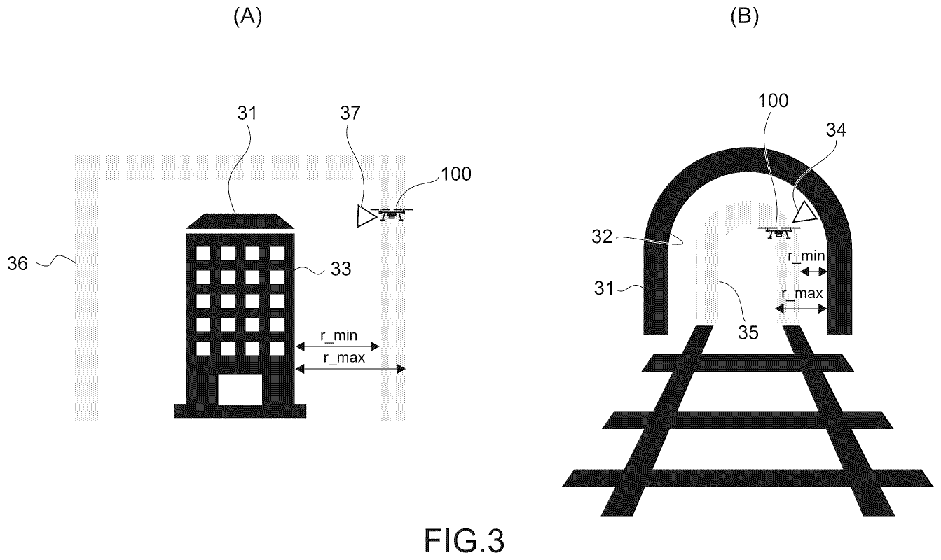

FIG. 3 illustrates a relative position (an inner side or an outer side) of a movement region relative to a target object.

A relative position 22 of a movement region relative to a target object 31 refers to an inner side and/or an outer side of the target object 31. For example, a tunnel, a building, a gas tank, and the like are each have the inner side and the outer side of the target object 31, that is, an inner wall surface 32 and an outer wall surface 33. A user may specify on which of the inner wall surface 32 and the outer wall surface 33 image-capturing is to be performed. Alternatively, the user may specify whether to perform image-capturing on both the inner wall surface 32 and the outer wall surface 33 in a single flight. Alternatively, particularly when image-capturing is performed on both the inner wall surface 32 and the outer wall surface 33 in a single flight or when the target object only includes the outer wall surface 33, as in the case of a windmill or a steel tower, the relative position 22 does not necessarily have to be input. The case of capturing an image of the inner wall surface 32 of a tunnel or a building and the case of calculating the volume of a building or a tank are taken as examples in which the outer side is specified as the relative position 22, as illustrated in (A). In this case, a movement region 36 situated around the outer wall surface 33 is moved to capture 37 an image of the outer wall surface 33. The case of capturing an image of a surface of, for example, a windmill or a steel tower and the case of calculating the volume of, for example, fill on a construction site are taken as examples in which the inner side is specified as the relative position 22, as illustrated in (B). In this case, a movement region 35 situated around the inner wall surface 32 is moved to capture 34 an image of the inner wall surface 32.

Examples of the parameter 23 for the image-capturing apparatus 104 include a focal length of a lens, a permissible circle of confusion for the lens, an f-number of the lens (an aperture value indicating a brightness of the lens), and a size of an image sensor. The parameter 23 for the image-capturing apparatus 104 may be automatically input by the mobile object 100.

The preferential movement route 24 is a route (in, for example, a vertical direction or a horizontal direction) that is to be given priority upon automatic flight.

The application 25 is an image-capturing application, and examples of the application 25 include image-capturing by 3D scanning and capturing of an ortho-image.

The overlap rate 26 refers to a rate at which images captured upon performing image-capturing during automatic flight overlap (images adjacent to each other overlap). When the overlap rate is high, an accurate 3D model is expected to be generated when, for example, the 3D model is generated from a plurality of still images. Further, when the mobile object 100 captures a video during automatic flight and displays video data on the display apparatus 204 in real time, a rate at which images adjacent to each other overlap in a direction orthogonal to a movement direction and to a direction relative to a target object may be specified as the overlap rate 26. In other words, it can also be said that the overlap rate 26 is a density of a movement route (a movement density).

Moreover, examples of the option 27 may include an upper limit for speed, a maximum flight time, upper and lower limits for flyable altitude, an image-capturing interval of time, and an image-capturing direction (such as an orientation of the lens 102 and a pose of the mobile object 100).

Next, the computational apparatus 203 generates a movement region in which the mobile object 100 can move, and a movement route (Step S3). The movement region and the movement route are described here.

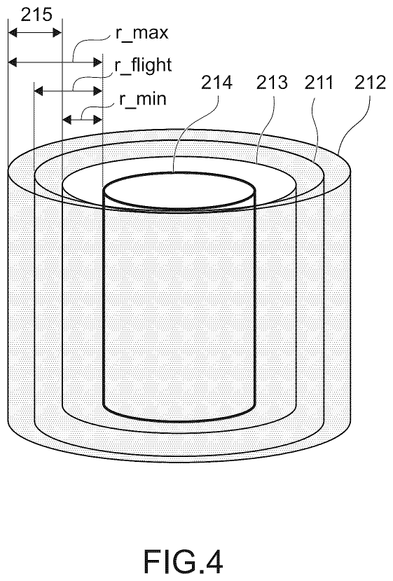

FIG. 4 schematically illustrates a target object, a movement region situated around the target object, and a recommended movement region in the movement region.

A movement region 215 is a model of a closed space region that is partitioned off by an outer geofence 212 (a first geofence) and an inner geofence 213 (a second geofence) and in which the mobile object 100 can move. The outer geofence 212 is generated far from a model 214 of a target object using a first specified distance, and covers the model 214 of the target object in the air. The inner geofence 213 is generated far from the model 214 of the target object between the model 214 of the target object and the outer geofence 212 using a second specified distance, and covers the model 214 of the target object in the air. The first specified distance is larger than the second specified distance. The recommended movement region 211 is generated in the movement region 215, and covers the model 214 of the target object in the air, the recommended movement region 211 being a region in which the mobile object 100 is recommended to move.

On the basis of various parameters and specified conditions, the computational apparatus 203 determines a maximum separation distance r_max from a target object to the mobile object 100, and a minimum separation distance r_min from the target object to the mobile object 100. The computational apparatus 203 generates the outer geofence 212 (the first geofence) of which at least a portion includes a group of points forming the maximum separation distance r_max, and the inner geofence 213 (the second geofence) of which at least a portion includes a group of points forming the minimum separation distance r_min. The computational apparatus 203 generates, as the movement region 215 of the mobile object 100, a closed space that is formed by the outer geofence 212 and the inner geofence 213. On the basis of various parameters and specified conditions, the computational apparatus 203 determines a recommended movement distance r_flight from the target object to the mobile object 100 in the movement region 215. The computational apparatus 203 generates, in the movement region 215, the recommended movement region 211 of which at least a portion includes a group of points forming the recommended movement distance r_flight. In other words, the computational apparatus 203 generates a model of the outer geofence 212, a model of the inner geofence 213, and the recommended movement region 211 by scaling up or down a 3D model of the target object (input in Step S1) or a model based on the 3D model of the target object. A method for the generation will be described in more detail later (Step S33).

Returning to the description on the flowchart. An operation performed by the computational apparatus 203 to generate a movement region and a movement route (Step S3) is described in detail.

First, on the basis of the relative position 22 (input in Step S2) of a movement region relative to a target object, the computational apparatus 203 determines whether to generate a model of a movement region of the mobile object 100 on an inner side or an outer side of a 3D model of the target object (input in Step S1) or to generate on both the inner side and the outer side continuously (Step S31). The phrase “on both the inner side and the outer side continuously” refers to, for example, moving (flying) on an outer side and an inner side of a tunnel continuously. When the movement region is generated on the outer side of the target object (for example, flying on the outer side of the tunnel), the inner geofence (the second geofence) is situated more outward than the target-object model, and the outer geofence (the first geofence) is situated most outward. On the other hand, when the movement region is generated on the inner side of the target object (for example, flying on the inner side of the tunnel), the inner geofence (the second geofence) is situated more inward than the target-object model, and the outer geofence (the first geofence) is situated most inward.

Next, the computational apparatus 203 generates the model of the outer geofence, the model of the inner geofence, the recommended movement region, and the movement region (Step S32).

Here, the computational apparatus 203 generates a different model of the outer geofence and a different model of the inner geofence according to the specification mode 21 (input in Step S2). Thus, the computational apparatus 203 generates a different movement region and a different recommended movement region according to the specification mode 21 (input in Step S2).

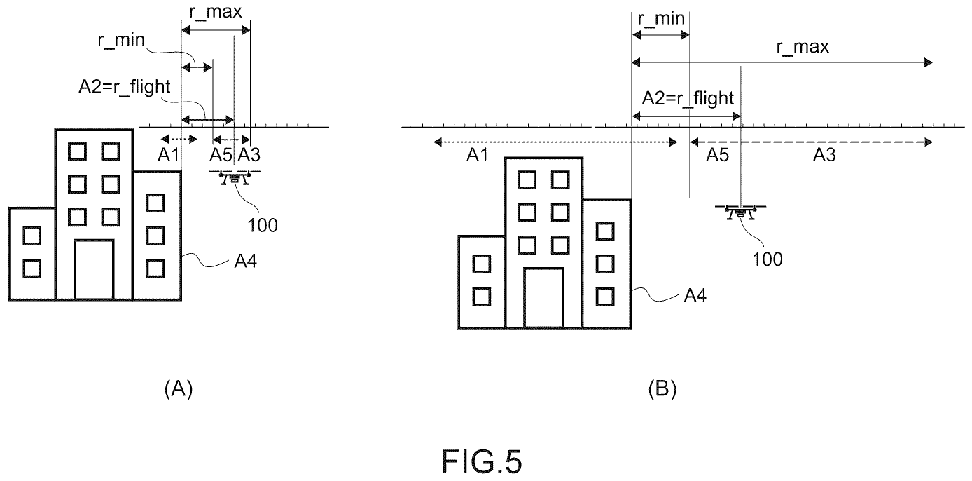

FIG. 5 schematically illustrates the case in which the depth of field is specified.

A depth of field A1 is a parameter that is specified when the mobile object 100 is desired to move in a range in which (with a depth of field with which) the focus of the image-capturing apparatus 104 is achieved. For example, when a user wants to bring, into focus, a small depth range in which a surface of a building corresponding to an inspection-target object A4 is situated and to cause a building behind the inspection-target object A4 to be blurred, as in the example illustrated in (A), the user specifies a distance range in a small depth (for example, 4 m) as a parameter for the depth of field A1. On the other hand, when the user wants to bring, into focus, a large depth range in which the entirety of the building corresponding to the inspection-target object A4 is situated and to cause clouds and the sky on the background to be blurred, as in the example illustrated in (B), the user specifies a distance range in a large depth (for example, 25 m) as the parameter for the depth of field A1. A subject distance A2 is smaller and a movable distance A3+A5 is smaller if the depth of field A1 is smaller, as in the example illustrated in (A). The subject distance A2 is larger and the movable distance A3+A5 is larger if the depth of field A1 is larger, as in the example illustrated in (B).

Using Simultaneous Equations (1) indicated below, the computational apparatus 203 calculates the subject distance A2 from the image-capturing apparatus 104 to the target object A4, a near depth of field A5, and a far depth of field A3 from a focal length of the lens 102, an f-number (an aperture value) of the lens 102, a permissible circle of confusion for the lens 102 (for example, 0.03 mm), and the depth of field A1.

$$Near depth of field A 5 = ( permissible circle of confusion \times aperture value \times subject {distance}^{2} ) / ( focal {length}^{2} + permissible circle of confusion \times aperture value \times subject distance ) \qquad ( 1 )$$

$$Far depth of field A 3 = ( permissible circle of confusion \times aperture value \times subject {distance}^{2} ) / ( focal {length}^{2} - permissible circle of confusion \times aperture value \times subject distance )$$

$$Depth of field = near depth of field A 5 + far depth of field A 3$$

The computational apparatus 203 determines the subject distance A2 as the recommended movement distance r_flight. The computational apparatus 203 adds the far depth of field A3 of the image-capturing apparatus 104 to the subject distance A2 (the recommended movement distance r_flight) to calculate the maximum separation distance r_max. The computational apparatus 203 subtracts the near depth of field A5 of the image-capturing apparatus 104 from the subject distance A2 (the recommended movement distance r_flight) to calculate the minimum separation distance r_min (Step S32A). The following is the summary of the description above.

$$r\_min = subject distance A 2 - near depth of field A 5$$

$$r\_flight = subject distance A 2$$

$$r\_max = subject distance A 2 + far depth of field A 3$$

For example, the subject distance A2 is calculated to be 5 m when the depth of field A1 is 4 m, as in the example illustrated in (A). The subject distance A2 is calculated to be 10 m when the depth of field A1 is 25 m, as in the example illustrated in (B).

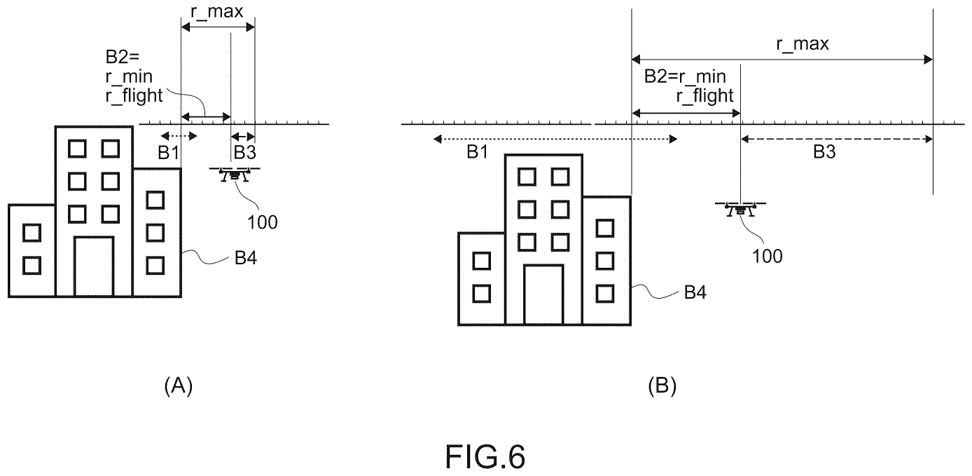

FIG. 6 schematically illustrates the case in which the separation distance is specified.

A separation distance B2 is a parameter that is specified when an image of a target object is desired to be captured in a state in which the mobile object 100 is situated as close to the target object as possible and the focus of the image-capturing apparatus 104 is desired to be also achieved when the mobile object 100 is distant from the target object B4. The user specifies a value of the separation distance B2 from the target object B4 to the mobile object 100 (that is, a subject distance) as a parameter. For example, when the user wants to bring, into focus, a small depth range in which a surface of a building corresponding to an inspection-target object B4 is situated (a depth of field B1 is small) and to cause a building behind the inspection-target object B4 to be blurred, as in the example illustrated in (A), the user specifies the separation distance B2 from the target object B4 to the mobile object 100 as being small (for example, 5 m). On the other hand, when the user wants to bring, into focus, a large depth range in which the entirety of the building corresponding to the inspection-target object B4 is situated (the depth of field B1 is large) and to cause clouds and the sky on the background to be blurred, as in the example illustrated in (B), the user specifies the separation distance B2 from the target object B4 to the mobile object 100 as being large (for example, 10 m).

Using Simultaneous Equations (1) indicated above, the computational apparatus 203 calculates a far depth of field B3 from the focal length of the lens 102, the f-number (the aperture value) of the lens 102, the permissible circle of confusion for the lens 102 (for example, 0.03 mm), and the subject distance (the separation distance B2).

The computational apparatus 203 determines the subject distance (the separation distance B2) as the recommended movement distance r_flight and as the minimum separation distance r_min. The computational apparatus 203 adds the far depth of field B3 of the image-capturing apparatus 104 to the subject distance (the separation distance B2) to calculate the maximum separation distance r_max (Step S32B). The following is the summary of the description above.

$$r\_min = subject distance B 2$$

$$r\_flight = subject distance B 2$$

$$r\_max = subject distance B 2 + far depth of field B 3$$

For example, when the separation distance B2 (the subject distance) is 5 m, the far depth of field B3 is 2.6 m, and the maximum separation distance r_max is calculated to be 7.6 m, as in the example illustrated in (A). When the separation distance B2 (the subject distance) is 10 m, the far depth of field B3 is 21 m, and the maximum separation distance r_max is calculated to be 31 m, as in the example illustrated in (B).

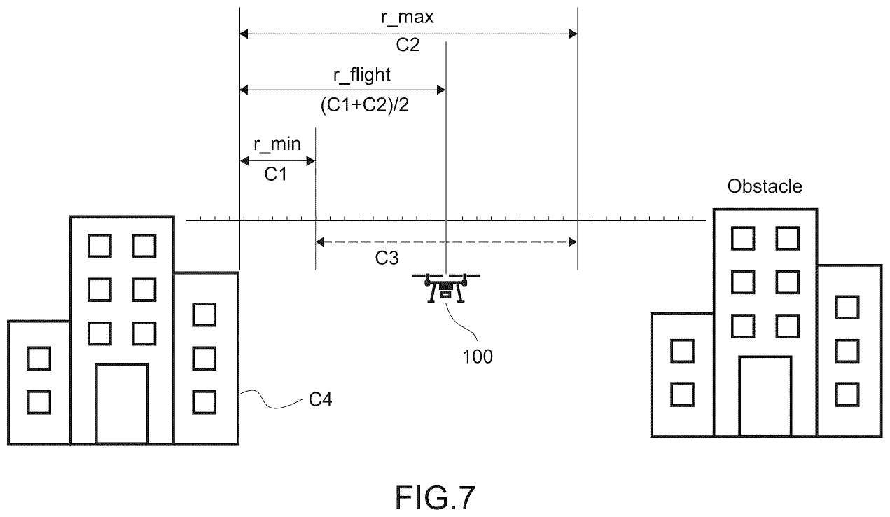

FIG. 7 schematically illustrates the case in which the minimum distance and the maximum distance (or the maximum resolution and the minimum resolution) are specified.

When the user wants to move the mobile object 100 in a maximum range in which an obstacle is physically not situated or in a maximum range in which an acceptable resolution can be obtained, the user specifies a minimum distance C1 and a maximum distance C2 (or a maximum resolution and a minimum resolution) as parameters.

The computational apparatus 203 determines, as the minimum separation distance r_min, the minimum distance C1, from a target object C4 to the mobile object 100, that the mobile object 100 can move. The computational apparatus 203 determines, as the maximum separation distance r_max, the maximum distance C2, from the target object C4 to the mobile object 100, that the mobile object 100 can move. The computational apparatus 203 determines, as the recommended movement distance r_flight, an average (r_min+r_max)/2 of the minimum separation distance r_min and the maximum separation distance r_max (Step S32C). The following is the summary of the description above.

$$r\_min = minimum distance C 1$$

$$r\_flight = ( C 1 + C 2 ) / 2 = ( r\_min + r\_max ) / 2$$

$$r\_max = maximum distance C 2$$

For example, when “minimum distance C1=5 m” and “maximum distance C2=25 m” are input as parameters, the minimum separation distance r_min is calculated to be 5 m, the maximum separation distance r_max is calculated to be 25 m, and the recommended movement distance r_flight is calculated to be 15 m. A movable range C3 is obtained as indicated below: maximum distance C2−minimum distance C1=25 m−5 m=20 m.

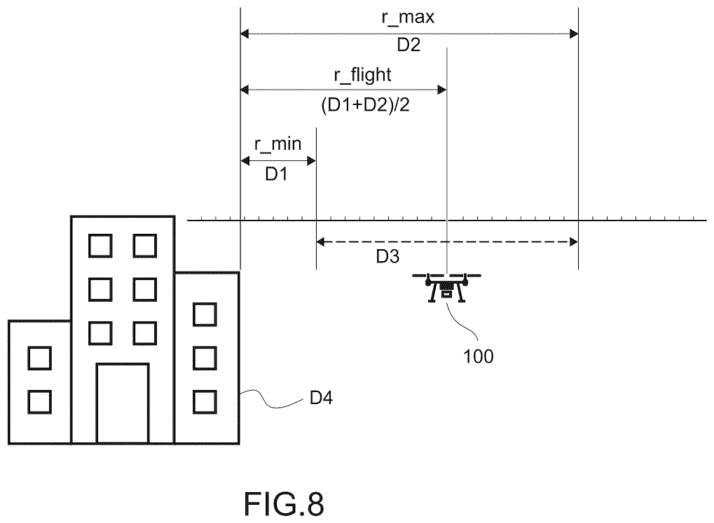

FIG. 8 schematically illustrates the case in which the minimum resolution is specified.

When the user wants to move the mobile object 100 in a range in which the resolution does not fall below a minimum resolution, with the focus being adjusted to infinity, the user specifies a value of the minimum resolution as a parameter.

The computational apparatus 203 calculates the minimum separation distance r_min on the basis of a hyperfocal length of the image-capturing apparatus 104. Specifically, the computational apparatus 203 calculates a value of (hyperfocal length/2) D1 as the minimum separation distance r_min. The hyperfocal length refers to a certain distance at which focus is considered to be achieved at infinity when the focus is at a distance larger than the certain distance. The hyperfocal length is calculated using Formula (3) indicated below.

$$hyperfocal length = focal {length}^{2} \times f - number \times permissible circle of confusion \qquad ( 3 )$$

For example, it is assumed that the focal length is 35 mm, the f-number is 2.8, and the permissible circle of confusion is 0.03 mm. The minimum separation distance r_min is calculated as indicated below: minimum separation distance r_min=(hyperfocal length/2) D1=(35²×2.8×0.03)/2=6 m.

On the basis of Formula (4) indicated below, the computational apparatus 203 determines, as the maximum separation distance r_max, a distance D2 at which the image-capturing apparatus 104 exhibits a minimum resolution.

$$r\_max = ( resolution ( mm / px ) \times focal length ) / {( sensor area / total number of pixels )}^{1 / 2} \qquad ( 4 )$$

The computational apparatus 203 determines, as the recommended movement distance r_flight, an average (r_min+r_max)/2 of the minimum separation distance r_min and the maximum separation distance r_max (Step S32D). The following is the summary of the description above.

$$r\_min = ( hyperfocal length ) / 2 ) D 1$$

$$r\_flight = ( D 1 + D 2 ) / 2 = ( r\_min + r\_max ) / 2$$

$$r\_max = distance D 2 at which minimum resolution is exhibited$$

For example, it is assumed that the resolution is 1 mm/px, the focal length is 35 mm, the sensor area is 35.7×23.8 mm², the total number of pixels is 61 million pixels. The maximum separation distance r_max is calculated as indicated below: maximum separation distance r_max=(1×35)/(35.7×23.8/61 millions)^{1/2}=10 m. Since the minimum separation distance r_min is 6 m and the maximum separation distance r_max is 10 m, the recommended movement distance r_flight is calculated as indicated below: recommended movement distance r_flight=(6+10)/2=8 m. The movable range D3 is obtained as indicated below: r_max−r_min=10 m−6 m=4 m.

On the other hand, when the recommendations E are specified by the user, the computational apparatus 203 specifies one of the parameters A) to (D as the specification mode 21 according to various parameters. Examples of the various parameters include, for example, the focal length of the lens 102, the f-number (the aperture value) of the lens 102, sizes of a 3D model of a target object in three directions, a level of depth of a change in a surface structure of the target object, the presence or absence of real-time kinematic (RTK) (there may be no need for RTK for C), a distance, from the target object to the mobile object 100, that ensures safety, an acceptable level of blur (easily blurred A>B>C>D not easily blurred), and a size of the target object (an image of a small target object can be captured A<B<C<D=it is difficult to capture an image of a small target object having a size of 6 m or less). The computational apparatus 203 the computational apparatus 203 calculates the maximum separation distance r_max, the minimum separation distance r_min, and the recommended movement distance r_flight according to a specified parameter from among the parameters A) to (D (Step S32E).

Next, the computational apparatus 203 determines whether the application 25 (input in Step S2) is image-capturing by 3D scanning or capturing of an ortho-image (Step S33).

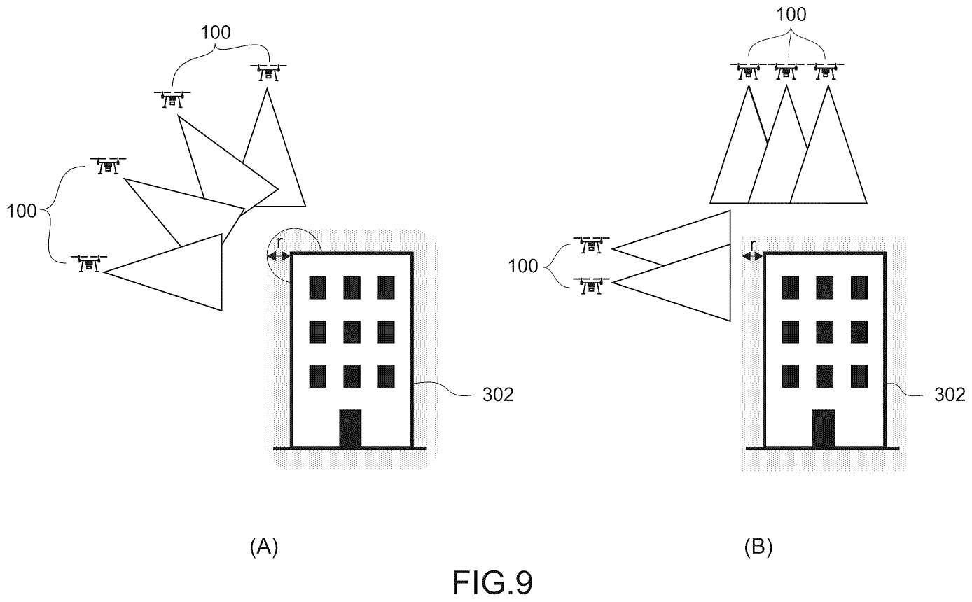

FIG. 9 schematically illustrates image-capturing by 3D scanning and capturing of an ortho-image.

When the application 25 is image-capturing by 3D scanning, the computational apparatus 203 generates three types of models that are each formed only of a group of points situated at equal distances r from points of a group of points forming a surface (a reference surface) of the 3D model 302 of a target object (input in Step S1), as illustrated in (A). Specifically, the computational apparatus 203 generates a model of an outer geofence that is formed only of a group of points situated at equal distances (r_max) from points of a group of points forming the surface (the reference surface) of the 3D model 302 of the target object (input in Step S1). The computational apparatus 203 generates a model of an inner geofence that is formed only of points situated at equal distances (r_min) from the respective points forming the surface (the reference surface) of the 3D model 302 of the target object. The computational apparatus 203 generates a recommended movement region that is formed only of points situated at equal distances (r_flight) from the respective points forming the surface (the reference surface) of the 3D model 302 of the target object. The model of the outer geofence, the model of the inner geofence, and the recommended movement region are each similar to the 3D model 302 of the target object (Step S33s). Note that triangles in the figure each schematically indicate an image-capturing field of view of the mobile object.

When the application 25 is capturing of an ortho-image, the computational apparatus 203 generates a reference model that includes at least a portion of the group of points forming the surface of the 3D model 302 of the target object (input in Step S1), as illustrated in (B). The reference model is, for example, a rectangular parallelepiped (w×d×h) in a gravity vertical direction. With respect to ground, the computational apparatus 203 scales up (when an image of the outer side of the target object is captured) or down (when an image of the inner side of the target object is captured) the rectangular parallelepiped (w×d×h) corresponding to the reference model. Specifically, the computational apparatus 203 substitutes each of r_max, r_min, and r_flight for a variable r in Formula (5) indicated below to generate a corresponding one of a model of an outer geofence, a model of an inner geofence, and a recommended movement region. The model of the outer geofence, the model of the inner geofence, and the recommended movement region are each formed of a group of points situated at equal distances from a surface (a reference surface) of the reference model and dissimilar to the 3D model 302 of the target object (Step S33o). Note that the model of the outer geofence, the model of the inner geofence, and the recommended movement region outer geofence may overlap on the basis of centers of gravity of the respective models. Alternatively, another method such as use of a point of intersection of a center of a ground-plane polygon and a midpoint in a height direction, input performed by a user, or movement horizontal to a ground plane may be adopted.

$$( w + / - 2 r ) \times ( d + / - 2 r ) \times ( h + / - r ) \qquad ( 5 )$$

The computational apparatus 203 superimposes to draw the model of the outer geofence, the model of the inner geofence, and the recommended movement region on the model 302 (displayed in Step S1) of the target object, and causes the model of the outer geofence, the model of the inner geofence, and the recommended movement region on the model 302 of the target object to be displayed on the display apparatus 204 viewed by the user (Step S33).

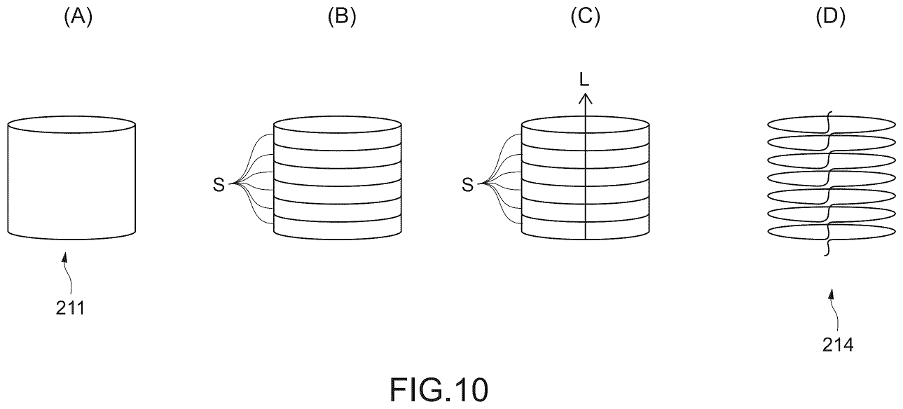

FIG. 10 schematically illustrates a method for generating a movement route.

The computational apparatus 203 slices the recommended movement region 211 (generated using r_flight) in (A) in parallel at equal intervals to generate slices S in (B). The computational apparatus 203 determines a slicing interval on the basis of, for example, the overlap rate 26 (input in Step S2). The computational apparatus 203 determines that a slicing direction (for example, a vertical direction or a horizontal direction) is, for example, a direction parallel to the preferential movement route 24 (for example, the vertical direction or the horizontal direction) (input in Step S2). The computational apparatus 203 may automatically determine the slicing interval and/or the slicing direction on the basis of, for example, how long a battery life is, how short a total flight time is, and a level of being less likely to be affected by the wind. This makes it possible to generate an optimal movement route.

The computational apparatus 203 connects surfaces of the slices S using a single line L (for example, a perpendicular), as illustrated in (C). The computational apparatus 203 may automatically determine a position of the single line L used to connect the slices S, or the position of the single line L may be determined by being specified by a user. The computational apparatus 203 may determine that the position of the single line L is, for example, a position situated closest to a flight start point, or a position that makes the total flight time shortest. When the position of the single line L is determined by being specified by the user, the user may specify connection points on a screen.

As illustrated in (D), the computational apparatus 203 converts the slices S and the single line L into a figure drawn without going over the same line twice to generate the movement route 214 of the mobile object 100 in the recommended movement region 211. The computational apparatus 203 superimposes to draw the movement route 214 on the model 302 of the target object (displayed in Step S1), the model of the outer geofence, the model of the inner geofence, and the recommended movement region (displayed in Step S33), and causes the movement route 214 on the model 302 of the target object, the model of the outer geofence, the model of the inner geofence, and the recommended movement region to be displayed on the display apparatus 204 viewed by the user (Step S34).

The user checks the movement route 214 displayed on the display apparatus 204. When the user wants to change the movement route 214 or when it is difficult to generate the movement route 214 according to the parameter, the process returns to Step S2, and the user inputs the parameter again. When the user determines the movement route 214, the user moves on to Step S5 using the input apparatus 202 (Step S4).

The computational apparatus 203 generates the determined movement range file 210. The movement range file 210 includes the recommended movement region 211, the outer geofence 212, the inner geofence 213, and the movement route 214. The file output apparatus 205 records, in the storage apparatus 206, the movement range file 210 including the recommended movement region 211, outer geofence 212, inner geofence 213, and movement route 214 generated by the computational apparatus 203 (Step S5).

The file output apparatus 205 transmits the movement range file 210 to the mobile object 100 through the communication apparatus 201. The mobile object 100 automatically flies along the movement route 214 included in the received movement range file 210, and moves in a movement region that is a closed space partitioned off by the outer geofence 212 and the inner geofence 213. When the mobile object 100 deviates from the movement route 214 due to, for example, a strong wind, the mobile object 100 moves to return to the movement route 214 in the movement region that is a closed space (Step S6).

### 5. Conclusion

According to the present embodiment, a model of an image-capturing-target object is scaled up or down, a range partitioned off by a plurality of models is defined as a closed three-dimensional space, and a movement route fit for the purpose of a user is generated in the range. It is sufficient if a mobile object moves on the movement route in the movement region. This results in a relatively small amount of information to be processed for controlling the mobile object and in improving the reliability in obtaining an appropriate image safely.

An appropriate scaled-up or scaled-down 3D model can be used by use of a scanning purpose (scanning of a surface of a target object or an ortho-image of an elevation surface) and an orientation of a camera (inward or outward), and an appropriate movement range can be obtained by specifying a desired depth of focus (a depth of field) or a desired resolution. Further, a movement route and an image-capturing plan can be automatically generated in the flight range by specifying several parameters such as an overlap rate.

As a modification, the mobile object 100 may move in a movement region by a manual operation performed by a user, without the recommended movement region 211 and movement route 214 being generated, where the movement region is a closed space partitioned by the outer geofence 212 and the inner geofence 213. It is sufficient if an air vehicle is caused to fly in the movement region when an operator causes the air vehicle to fly by a manual operation. This results in an easier operation and thus in improving the reliability in obtaining an appropriate image.

The present disclosure may also include the following configurations.
(1) An information processing method, including:
   generating a first geofence spaced from a target object;
   generating a second geofence spaced from the target object and different from the first geofence; and
   generating, using the first geofence and the second geofence, a movement region in which a mobile object is movable.
(2) The information processing method according to (1), in which
   the first geofence is generated far from the target object using a first specified distance,
   the second geofence is generated far from the target object using a second specified distance, and
   the first specified distance is larger than the second specified distance.
(3) The information processing method according to (2), in which
   the second geofence is generated between the target object and the first geofence.
(4) The information processing method according to any one of (1) to (3), in which
   a recommended movement region in which the mobile object is recommended to move is generated in the movement region.
(5) The information processing method according to any one of (1) to (4), in which
   a movement route of the mobile object is generated in the recommended movement region.
(6) The information processing method according to (4) or (5), in which
   the recommended movement region is sliced to generate slices, the slices are connected using a single line, and the slices and the single line are converted into a figure drawn without going over the same line twice to generate a movement route of the mobile object in the recommended movement region.
(7) The information processing method according to (5) or (6), in which
   the movement route is output to the mobile object.
(8) The information processing method according to any one of (4) to (7), in which
   a target-object model that is a model of the target object is acquired, and
   the target-object model is scaled up or down to generate each of the first geofence, the second geofence, and the recommended movement region.
(9) The information processing method according to (8), in which
   the target-object model, the first geofence, or the second geofence is a 3D model.
(10) The information processing method according to (8) or (9), in which
   the mobile object includes an image-capturing apparatus,
   when an image of the target object is captured by 3D scanning,
      each of the first geofence, the second geofence, and the recommended movement region is formed of a group of points situated at equal distances from a reference surface, with a surface of the target-object model being set to be the reference surface, each of the first geofence, the second geofence, and the recommended movement region being similar to the target-object model, and
   when an ortho-image of the target object is captured,
      each of the first geofence, the second geofence, and the recommended movement region is formed of a group of points situated at equal distances from a reference surface, with a surface of a refence model being set to be the reference surface, the reference model including at least a portion of a group of points forming the surface of the target-object model, each of the first geofence, the second geofence, and the recommended movement region being dissimilar to the target-object model.
(11) The information processing method according to any one of (4) to (10), in which
   the recommended movement region of which at least a portion includes a group of points each spaced at a recommended movement distance from a reference surface based on the target object is generated,
   the second geofence of which at least a portion includes a group of points each spaced at a minimum separation distance from the reference surface is generated, and
   the first geofence of which at least a portion includes a group of points each spaced at a maximum separation distance from the reference surface is generated.
(12) The information processing method according to (11), in which
   the mobile object includes an image-capturing apparatus,
   a subject distance at which focus of the image-capturing apparatus is achieved when the image-capturing apparatus captures an image of the target object is determined to be the recommended movement distance,
   a near depth of field of the image-capturing apparatus is subtracted from the subject distance to calculate the minimum separation distance, and
   a far depth of field of the image-capturing apparatus is added to the subject distance to calculate the maximum separation distance.
(13) The information processing method according to (11), in which
   the mobile object includes an image-capturing apparatus,
   a subject distance at which focus of the image-capturing apparatus is achieved when the image-capturing apparatus captures an image of the target object is determined to be the recommended movement distance,
   the subject distance is determined to be the minimum separation distance, and
   a far depth of field of the image-capturing apparatus is added to the subject distance to calculate the maximum separation distance.
(14) The information processing method according to (11), in which
   a minimum distance, from the target object to the mobile object, that the mobile object is movable is determined to be the minimum separation distance,
   a maximum distance, from the target object to the mobile object, that the mobile object is movable is determined to be the maximum separation distance, and
   an average of the minimum separation distance and the maximum separation distance is determined to be the recommended movement distance.
(15) The information processing method according to (11), in which
   the mobile object includes an image-capturing apparatus,
   the minimum separation distance is calculated on the basis of a hyperfocal length of the image-capturing apparatus,
   a distance at which the image-capturing apparatus exhibits a minimum resolution is determined to be the maximum separation distance, and
   an average of the minimum separation distance and the maximum separation distance is determined to be the recommended movement distance.
(16) An information processing apparatus, including
   a computational apparatus
      that generates a first geofence spaced from a target object,
      that generates a second geofence spaced from the target object and different from the first geofence, and
      that generates, using the first geofence and the second geofence, a movement region in which a mobile object is movable.
(17) An information processing program that operates a computational apparatus of an information processing apparatus to
   generate a first geofence spaced from a target object,
   generate a second geofence spaced from the target object and different from the first geofence, and
   generate, using the first geofence and the second geofence, a movement region in which a mobile object is movable.
(18) An information processing system, including:
   a mobile object; and
   an information processing apparatus including a computational apparatus
      that generates a first geofence spaced from a target object,
      that generates a second geofence spaced from the target object and different from the first geofence,
      that generates, using the first geofence and the second geofence, a movement region in which a mobile object is movable,
      that generates, in the movement region, a recommended movement region in which the mobile object is recommended to move,
      that generates a movement route of the mobile object in the recommended movement region, and
      that outputs the movement route to the mobile object.
(19) A non-transitory computer-readable recording medium that records therein an information processing program that operates a computational apparatus of an information processing apparatus to
   generate a first geofence spaced from a target object,
   generate a second geofence spaced from the target object and different from the first geofence, and
   generate, using the first geofence and the second geofence, a movement region in which a mobile object is movable.

The embodiments and the modifications of the present technology have been described above. Of course the present technology is not limited to the embodiments described above, and various modifications may be made thereto without departing from the scope of the present technology.

### REFERENCE SIGNS LIST

1 information processing system
100 mobile object
101 communication apparatus
102 lens
103 camera
104 image-capturing apparatus
105 GNSS unit
106 ranging sensor
107 flight control apparatus
200 information processing apparatus
201 communication apparatus
202 input apparatus
203 computational apparatus
204 display apparatus
205 file output apparatus
206 storage apparatus
300 server apparatus
301 map data
302 model of target object

1. An information processing method, comprising:
generating a first geofence spaced from a target object;
generating a second geofence spaced from the target object and different from the first geofence; and
generating, using the first geofence and the second geofence, a movement region in which a mobile object is movable.

2. The information processing method according to claim 1, wherein
the first geofence is generated far from the target object using a first specified distance,
the second geofence is generated far from the target object using a second specified distance, and
the first specified distance is larger than the second specified distance.

3. The information processing method according to claim 2, wherein
the second geofence is generated between the target object and the first geofence.

4. The information processing method according to claim 1, wherein
a recommended movement region in which the mobile object is recommended to move is generated in the movement region.

5. The information processing method according to claim 4, wherein
a movement route of the mobile object is generated in the recommended movement region.

6. The information processing method according to claim 4, wherein
the recommended movement region is sliced to generate slices, the slices are connected using a single line, and the slices and the single line are converted into a figure drawn without going over the same line twice to generate a movement route of the mobile object in the recommended movement region.

7. The information processing method according to claim 5, wherein
the movement route is output to the mobile object.

8. The information processing method according to claim 4, wherein
a target-object model that is a model of the target object is acquired, and
the target-object model is scaled up or down to generate each of the first geofence, the second geofence, and the recommended movement region.

9. The information processing method according to claim 8, wherein
the target-object model, the first geofence, or
the second geofence is a 3D model.

10. The information processing method according to claim 8, wherein
the mobile object includes an image-capturing apparatus,
when an image of the target object is captured by 3D scanning,
each of the first geofence, the second geofence, and the recommended movement region is formed of a group of points situated at equal distances from a reference surface, with a surface of the target-object model being set to be the reference surface, each of the first geofence, the second geofence, and the recommended movement region being similar to the target-object model, and
when an ortho-image of the target object is captured,
each of the first geofence, the second geofence, and the recommended movement region is formed of a group of points situated at equal distances from a reference surface, with a surface of a refence model being set to be the reference surface, the reference model including at least a portion of a group of points forming the surface of the target-object model, each of the first geofence, the second geofence, and the recommended movement region being dissimilar to the target-object model.

11. The information processing method according to claim 4, wherein
the recommended movement region of which at least a portion includes a group of points each spaced at a recommended movement distance from a reference surface based on the target object is generated,
the second geofence of which at least a portion includes a group of points each spaced at a minimum separation distance from the reference surface is generated, and
the first geofence of which at least a portion includes a group of points each spaced at a maximum separation distance from the reference surface is generated.

12. The information processing method according to claim 11, wherein
the mobile object includes an image-capturing apparatus,
a subject distance at which focus of the image-capturing apparatus is achieved when the image-capturing apparatus captures an image of the target object is determined to be the recommended movement distance,
a near depth of field of the image-capturing apparatus is subtracted from the subject distance to calculate the minimum separation distance, and
a far depth of field of the image-capturing apparatus is added to the subject distance to calculate the maximum separation distance.

13. The information processing method according to claim 11, wherein
the mobile object includes an image-capturing apparatus,
a subject distance at which focus of the image-capturing apparatus is achieved when the image-capturing apparatus captures an image of the target object is determined to be the recommended movement distance,
the subject distance is determined to be the minimum separation distance, and
a far depth of field of the image-capturing apparatus is added to the subject distance to calculate the maximum separation distance.

14. The information processing method according to claim 11, wherein
a minimum distance, from the target object to the mobile object, that the mobile object is movable is determined to be the minimum separation distance,
a maximum distance, from the target object to the mobile object, that the mobile object is movable is determined to be the maximum separation distance, and
an average of the minimum separation distance and the maximum separation distance is determined to be the recommended movement distance.

15. The information processing method according to claim 11, wherein
the mobile object includes an image-capturing apparatus,
the minimum separation distance is calculated on a basis of a hyperfocal length of the image-capturing apparatus,
a distance at which the image-capturing apparatus exhibits a minimum resolution is determined to be the maximum separation distance, and
an average of the minimum separation distance and the maximum separation distance is determined to be the recommended movement distance.

16. An information processing apparatus,
comprising
a computational apparatus that generates a first geofence spaced from a target object,
that generates a second geofence spaced from the target object and different from the first geofence, and
that generates, using the first geofence and the second geofence, a movement region in which a mobile object is movable.

17. An information processing program that operates a computational apparatus of an information processing apparatus to
generate a first geofence spaced from a target object,
generate a second geofence spaced from the target object and different from the first geofence, and
generate, using the first geofence and the second geofence, a movement region in which a mobile object is movable.

18. An information processing system, comprising:
a mobile object; and
an information processing apparatus including a computational apparatus
that generates a first geofence spaced from a target object,
that generates a second geofence spaced from the target object and different from the first geofence,
that generates, using the first geofence and the second geofence, a movement region in which a mobile object is movable,
that generates, in the movement region, a recommended movement region in which the mobile object is recommended to move,
that generates a movement route of the mobile object in the recommended movement region, and
that outputs the movement route to the mobile object.
